(19) United States
(12) Patent Application Publication
(10) Pub. No.: US 2024/0183990 A1
(43) Pub. Date: Jun. 6, 2024

(54) ELECTROMAGNETIC-WAVE DETECTION DEVICE

(71) Applicant: KYOCERA Corporation, Kyoto (JP)

(72) Inventors: Koichi HOSHINO, Yokohama-shi, Kanagawa (JP); Hiroki OKADA, Machida-shi, Tokyo (JP); Kousuke SHIRAYAMA, Yokohama-shi, Kanagawa (JP)

(73) Assignee: KYOCERA Corporation, Kyoto (JP)

(21) Appl. No.: 18/550,646

(22) PCT Filed: Mar. 10, 2022
(86) PCT No.: PCT/JP2022/010730

§ 371 Date: Sep. 14, 2023

(30) Foreign Application Priority Data
Mar. 17, 2021 (JP) 2021-044023

(51) Int. Cl. G01S 17/89

(52) U.S. Cl. CPC G01S 17/89

(57) ABSTRACT

An electromagnetic-wave detection device 10 includes a first detection unit 13, a second detection unit 14, a first aperture 15, a second aperture 16, and a controller 18. The first detection unit 13 detects reflected waves incident from an incidence unit 12. The second detection unit 14 detects electromagnetic waves incident from the incidence unit 12. The second aperture 16 has a second region and a third region. The second region is smaller than a first region. The third region is located around the second region. The third region does not allow electromagnetic waves traveling to the second detection unit 14 to pass therethrough. The controller 18 acquires first spatial information about a space based on detection of electromagnetic waves by the first detection unit 13. The controller 18 acquires second spatial information about the space based on detection of electromagnetic waves by the second detection unit 14.

### CROSS-REFERENCE TO RELATED APPLICATIONS

This application claims priority from Japanese Patent Application No. 2021-044023 filed in Japan on Mar. 17, 2021, and the entire disclosure of this application is hereby incorporated by reference.

### TECHNICAL FIELD

The present disclosure relates to an electromagnetic-wave detection device.

### BACKGROUND OF INVENTION

In recent years, devices have been developed that obtain information about the surroundings from detection results acquired by multiple detectors that detect electromagnetic waves. For example, a known device measures the position of an object within an image using reflected waves out of electromagnetic waves with which an object has been irradiated (refer to Patent Literature 1).

### CITATION LIST

### Patent Literature

Patent Literature 1: Japanese Unexamined Patent Application Publication No. 2018-200927

### SUMMARY

In a First Aspect of the present disclosure, an electromagnetic-wave detection device includes a radiating unit, an incidence unit, a first detection unit, a second detection unit, a first aperture, a second aperture, an optical system, and a controller.

The radiating unit is configured to radiate electromagnetic waves into a space.

Electromagnetic waves are incident on the incidence unit, the electromagnetic waves including reflected waves resulting from electromagnetic waves radiated by the radiating unit being reflected by an object.

The first detection unit is configured to detect reflected waves incident from the incidence unit.

The second detection unit is configured to detect electromagnetic waves incident from the incidence unit.

The first aperture has a first region that allows electromagnetic waves traveling to the first detection unit and the second detection unit to pass therethrough.

The second aperture has a second region and a third region. The second region allows electromagnetic waves traveling to the first detection unit and the second detection unit to pass therethrough and is smaller than the first region. The third region is located around the second region and does not allow electromagnetic waves traveling to the second detection unit to pass therethrough.

The optical system is configured to, out of electromagnetic waves that have passed through the first aperture and the second aperture, guide a first portion, including the reflected waves, to the first detection unit and a second portion, excluding the first portion, to the second detection unit.

The controller is configured to acquire first spatial information about the space based on detection of electromagnetic waves by the first detection unit and second spatial information about the space based on detection of electromagnetic waves by the second detection unit.

A resolution of the first spatial information is lower than a resolution of the second spatial information.

### BRIEF DESCRIPTION OF THE DRAWINGS

FIG. 1 is a configuration diagram illustrating an outline configuration of an electromagnetic-wave detection device according to an embodiment.

FIG. 2 is a layout diagram in which the layout of a radiating unit, an incidence unit, and a first aperture in FIG. 1 are viewed in the direction of an optical axis of the incidence unit.

FIG. 3 is a front view in which a second aperture in FIG. 1 is compared with the first aperture.

FIG. 4 is a partial state diagram for the electromagnetic-wave detection device for illustrating the direction of travel of electromagnetic waves in a first state and a second state of switching elements in a switching unit of the electromagnetic-wave detection device in FIG. 1.

FIG. 5 is a timing chart illustrating the timing of the emission of electromagnetic waves and the timing of detection of electromagnetic waves in order to explain the principles of distance measurement carried out by a distance measurement sensor including a radiating unit, a first detection unit, and a controller in FIG. 1.

FIG. 6 is a side view of a mobile object equipped with the electromagnetic-wave detection device in FIG. 1.

FIG. 7 is a flowchart for describing opening adjustment processing executed by a controller in FIG. 1.

FIG. 8 is a partial configuration diagram illustrating an outline configuration of a variation of the electromagnetic-wave detection device according to the embodiment.

### DESCRIPTION OF EMBODIMENTS

Hereafter, an embodiment of an electromagnetic-wave detection device to which the present disclosure is applied will be described while referring to the drawings.

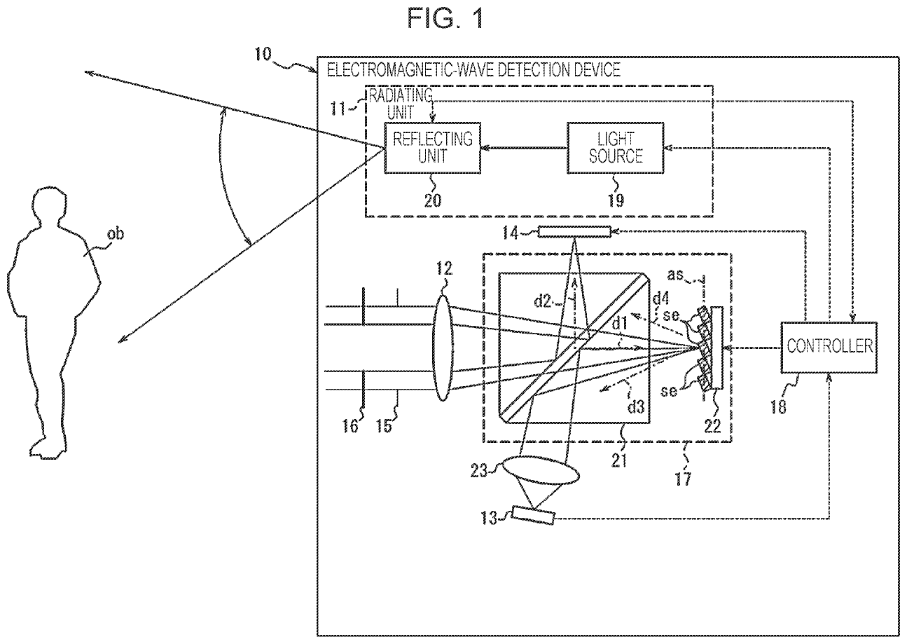

As illustrated in FIG. 1, an electromagnetic-wave detection device 10 according to an embodiment of the present disclosure includes a radiating unit 11, an incidence unit 12, a first detection unit 13, a second detection unit 14, a first aperture 15, a second aperture 16, an optical system 17, and a controller 18.

In the drawings referred to below, dashed lines connecting individual functional blocks to each other represent the flow of control signals or information being communicated. Communication represented by the dashed lines may be wired or wireless communication. Solid lines projecting from the individual functional blocks represent electromagnetic waves in the form of beams.

The radiating unit 11 radiates electromagnetic waves into a space. The radiating unit 11 may change an irradiated position of electromagnetic waves radiated to an object ob within the space by emitting electromagnetic waves in multiple different directions in the space. The radiating unit 11 may scan the object ob using radiated electromagnetic waves. In this embodiment, the radiating unit 11 may be configured as a scanning distance measurement sensor that operates in cooperation with the first detection unit 13, which is described later. The radiating unit 11 may scan the object ob in one or two dimensional directions. In this embodiment, the radiating unit 11 scans the object ob in two dimensional directions.

The radiating unit 11 is configured so that at least part of a radiation region of electromagnetic waves is included in an electromagnetic wave detection range of the electromagnetic-wave detection device 10. More specifically, the radiating unit 11 is configured so that at least part of the region irradiated with the radiated electromagnetic waves is included in a detection range of the first detection unit 13. Therefore, at least a portion of reflected waves reflected from the object ob out of the radiated electromagnetic waves can be detected by the first detection unit 13.

The radiating unit 11 may specifically include a light source 19 and a reflecting unit 20.

The light source 19 may emit at least one out of infrared rays, visible light, ultraviolet rays, and radio waves. In this embodiment, the light source 19 radiates infrared rays. The light source 19 may emit a narrow beam of electromagnetic waves, for example, having a width of 0.5°. The light source 19 may emit electromagnetic waves in the form of pulses. The light source 19 may switch between radiating and stopping radiating electromagnetic waves based on control performed by the controller 18 described later. The light source 19 includes, for example, a laser diode (LD) or a light emitting diode (LED).

The reflecting unit 20 may reflect the electromagnetic waves radiated from the light source 19 in different directions, and thereby cause the electromagnetic waves emitted by the light source 19 to be radiated in multiple different directions in the space. The reflecting unit 20 may change the direction in which the electromagnetic waves are reflected based on control performed by the controller 18, which is described later. The reflecting unit 20 includes, for example, a microelectromechanical systems (MEMS) mirror, a polygon mirror, or a galvanometer mirror.

The radiating unit 11 may radiate electromagnetic waves into the space without the electromagnetic waves passing through the incidence unit 12. Alternatively, the radiating unit 11 may, for example, include a mirror or the like on the image side of the incidence unit 12 and radiate electromagnetic waves via the incidence unit 12 into the space.

Electromagnetic waves from the space are incident on the incidence unit 12. Electromagnetic waves from the space may include reflected waves resulting from electromagnetic waves radiated by the radiating unit 11 being reflected by an object within the space. The incidence unit 12 may, for example, include at least one out of a lens and a mirror in order to form an image of the object ob, which is a subject.

The first detection unit 13 detects reflected waves incident from the incidence unit 12, in other words, reflected waves generated by the electromagnetic waves radiated by the radiating unit 11 being reflected by the object ob in the space of the electromagnetic waves and that are contained in the electromagnetic waves incident on the incidence unit 12. The first detection unit 13 may detect electromagnetic waves such as at least one out of infrared rays, visible light, ultraviolet rays, and radio waves. The first detection unit 13 may detect electromagnetic waves in the same band as those radiated by the radiating unit 11. The first detection unit 13 may transmit detection information to the controller 18 as a signal, the detection information indicating that the first detection unit 13 has detected reflected waves from an object.

The first detection unit 13 more specifically includes an element constituting a distance measurement sensor. For example, the first detection unit 13 includes a single element such as an avalanche photodiode (APD), a photodiode (PD), or a distance measurement image sensor. The first detection unit 13 may include an array of elements such as an APD array, a PD array, a distance measurement imaging array, or a distance measurement image sensor.

The reflected waves are incident on the first detection unit 13 via the optical system 17, as described below. The first detection unit 13 may be located near an image formation position, which is defined by the incidence unit 12 via the optical system 17, of an image of the object ob, which is at a prescribed position away from the incidence unit 12. Alternatively, the first detection unit 13 may be provided near the image formation position of an image-forming element such as a lens or a mirror provided along the path of electromagnetic waves traveling via the incidence unit 12 as described later.

The second detection unit 14 detects the electromagnetic waves incident from the incidence unit 12. The electromagnetic waves are incident on the second detection unit 14 via the optical system 17, as described later. The second detection unit 14 may be located at or near an image formation position, which is defined by the incidence unit 12 via the optical system 17, of an image of the object ob, which is at a prescribed position away from the incidence unit 12.

The second detection unit 14 may include an element array. For example, the second detection unit 14 may include an image-capturing element, such as an image sensor or imaging array, that captures an image from the electromagnetic waves formed on the detection surface and may generate image information corresponding to the captured object ob. The second detection unit 14 may further specifically capture a visible light image. The second detection unit 14 may transmit the generated image information as a signal to the controller 18.

The second detection unit 14 may capture images other than visible light images such as infrared ray, ultraviolet ray, and radio wave images. The second detection unit 14 may include a distance measurement sensor. In a configuration where the second detection unit 14 includes a distance measurement sensor, the electromagnetic-wave detection device 10 can acquire distance information in the form of an image using the second detection unit 14. The second detection unit 14 may include a thermosensor or the like. In a configuration where the second detection unit 14 includes a thermosensor, the electromagnetic-wave detection device 10 can acquire temperature information in the form of an image using the second detection unit 14.

The first aperture 15 has a first region that allows electromagnetic waves traveling to the first detection unit 13 and the second detection unit 14 to pass therethrough. The first aperture 15 may regulate the amount of electromagnetic waves that pass therethrough by blocking the progression of electromagnetic waves to the first detection unit 13 and the second detection unit 14 outside the first region.

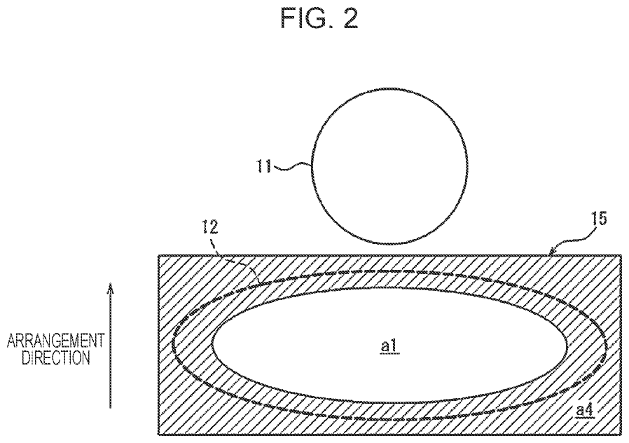

The shape of the first region in the first aperture 15 may be any shape, for example, circular, oval, rounded quadrangle, and so on. As illustrated in FIG. 2, a first region a1 may have a large diameter in a direction that intersects the direction in which the radiating unit 11 is arranged relative to the incidence unit 12. More specifically, the first region a1 may have a large diameter in a direction perpendicular to that arrangement direction.

The first region a1 of the first aperture 15 may be a wavelength filter that is able to transmit therethrough electromagnetic waves traveling to the first detection unit 13 and the second detection unit 14, for example, visible light and reflected waves generated by the electromagnetic waves radiated by the radiating unit 11 being reflected by an object. Alternatively, the first aperture 15 may be a variable aperture in which the size of an opening can be varied, in other words, the size of the first region a1 of the first aperture 15 can be varied. In a configuration in which the first aperture 15 is a variable aperture, the size of the opening of the first aperture 15 may be adjusted based on control performed by the controller 18, which is described later. A region a4 of the first aperture 15, which is a region of the first aperture 15 other than the first region a1, may be a region that does not allow electromagnetic waves to pass therethrough. Electromagnetic waves other than the electromagnetic waves that pass through the first aperture a1 may be blocked by the first aperture 15.

The first aperture 15 may be disposed at any position on the path along which the electromagnetic waves incident on the incidence unit 12 travel. For example, the first aperture 15 may be disposed on the object side from the incidence unit 12, or may be disposed inside the incidence unit 12 or on the image side from the incidence unit 12 in a configuration where the incidence unit 12 is composed of multiple optical elements. The first aperture 15 may be disposed so that the center of the first region a1 coincides with the optical axis of the incidence unit 12, regardless of the shape of the first region a1.

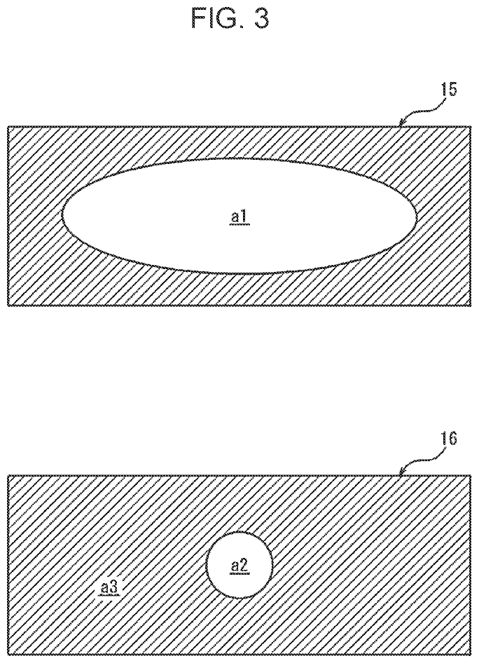

As illustrated in FIG. 3, the second aperture 16 has a second region a2 and a third region a3 disposed around the second region a2.

The second region a2 allows the electromagnetic waves traveling to the first detection unit 13 and the second detection unit 14 to pass therethrough. The second region a2 is smaller than the first region a1. More specifically, in a shape where the first aperture 15 has a major diameter and a minor diameter, such as an oval or a rectangle, the minor diameter of the first region a1 may be greater than or equal to than the diameter of the second region a2. The shape of the second region a2 in the second aperture 16 may be any shape, for example, circular, oval, rounded quadrangle, and so on.

The third region a3 does not allow the electromagnetic waves to pass through to the second detection unit 14. The third region a3 may allow the electromagnetic waves to pass through to the first detection unit 13. The third region a3, for example, does not allow electromagnetic waves in the visible light band to pass therethrough, but does allow reflected waves generated by electromagnetic waves in the infrared band radiated by the radiating unit 11 being reflected by an object to pass therethrough. The area of the third region a3 may be larger than the area of the first region a1.

The second aperture 16 may regulate the amount of electromagnetic waves that pass therethrough by blocking the progress of the electromagnetic waves to the second detection unit 14 in the third region a3.

The second region a2 of the second aperture 16 may be a wavelength filter that is able to transmit therethrough electromagnetic waves traveling to the first detection unit 13 and the second detection unit 14, for example, visible light and reflected waves generated by the electromagnetic waves radiated by the radiating unit 11 being reflected by an object. The third region a3 of the second aperture 16 may be a wavelength filter that blocks transmission of electromagnetic waves traveling to the second detection unit 14, such as visible light, for example, and allows transmission of electromagnetic waves in the infrared band, for example, that travel to the first detection unit 13, such as reflected waves generated by the electromagnetic waves emitted by the radiating unit 11 being reflected by an object.

The second aperture 16 may be disposed at any position on the path along which the electromagnetic waves incident on the incidence unit 12 travel. For example, the second aperture 16 may be disposed on the object side from the incidence unit 12, may be disposed inside the incidence unit 12 in a configuration where the incidence unit 12 is composed of multiple optical elements, or may be disposed on the image side from the incidence unit 12. In this embodiment, the second aperture 16 is disposed on the object side from the incidence unit 12. The second aperture 16 may be disposed so that the centers of the second region a2 and the third region a3 coincide with the optical axis, regardless of the shape of the second region a2.

As illustrated in FIG. 1, the optical system 17 directs a first portion of the electromagnetic waves that have passed through the first aperture 15 and second aperture 16 to the first detection unit 13. The first portion is a component that contains at least the reflected waves. The optical system 17 directs a second portion of the electromagnetic waves that have passed through the first aperture 15 and second aperture 16 to the second detection unit 14. The second portion is a portion of the electromagnetic waves that have passed through the first aperture 15 and the second aperture 16, other than the first portion. For example, the first portion may be electromagnetic waves in the infrared band and the second portion may be electromagnetic waves in the visible band.

The optical system 17 may include a separation unit 21 that directs the first portion to the first detection unit 13 and the second portion to the second detection unit 14. The separation unit 21 may be provided on the path along which the electromagnetic waves that have passed through the incidence unit 12 travel.

The separation unit 21 may be provided between the incidence unit 12 and a primary image formation position, which is determined by the incidence unit 12, of the image of the object ob at a prescribed position away from the incidence unit 12. The separation unit 21 may separate the incident electromagnetic waves so that the separated beams of electromagnetic waves travel in a first direction d1 and a second direction d2.

The first detection unit 13 may be provided in the first direction d1 with respect to the separation unit 21. Alternatively, a switching unit 22 may be provided in the first direction d1 with respect to the separation unit 21, the switching unit 22 being able to make the electromagnetic waves travel to the first detection unit 13, as described below. The second detection unit 14 may be provided in the second direction d2 with respect to the separation unit 21.

More specifically, in this embodiment, the separation unit 21 transmits the first portion of the incident electromagnetic waves in the first direction d1 and reflects the second portion of the incident electromagnetic waves in the second direction d2. The separation unit 21 may transmit the first portion of the incident electromagnetic waves in the first direction d1 and transmit the second portion of the incident electromagnetic waves in the second direction d2. The separation unit 21 may refract a portion of the incident electromagnetic waves in the first direction d1 and may refract another portion of the incident electromagnetic waves in the second direction d2. The separation unit 21 is, for example, a half mirror, a beam splitter, a dichroic mirror, a cold mirror, a hot mirror, a metasurface, a deflector element, or a prism. In this embodiment, the separation unit 21 is configured by sandwiching a wavelength selective filter between two prisms.

The optical system 17 may further include the switching unit 22. The switching unit 22 may be provided in the first direction d1 relative to the separation unit 21. The switching unit 22 may be provided at or near the primary image formation position, which is defined by the incidence unit 12 in the first direction d1 from the separation unit 21, of the image of the object ob at a prescribed position away from the incidence unit 12.

The switching unit 22 may have an action surface as on which the first portion of the electromagnetic waves that have passed through the incidence unit 12 and the separation unit 21 is incident. The action surface as may include multiple switching elements se arrayed in a two-dimensional pattern. The action surface as is a surface that produces an action such as reflection or transmission on electromagnetic waves in at least one out of a first state and a second state, which are described later.

The switching unit 22 may be capable of switching each switching element se between the first state in which the electromagnetic waves incident on the action surface as are made to travel in a third direction d3 and the second state in which the electromagnetic waves incident on the action surface as are made to travel in a fourth direction d4. The switching unit 22 may further specifically include a reflective surface that reflects electromagnetic waves in each switching element se. The switching unit 22 may switch each switching element se between the first state and the second state by changing the orientation of the reflective surface of each switching element se.

The first detection unit 13 may be provided on the path of the electromagnetic waves traveling in the third direction d3 with respect to the switching unit 22. Specifically, the first detection unit 13 may be provided in the third direction d3 with respect to the switching unit 22. Alternatively, the first detection unit 13 may be provided in the direction of reflection produced by a reflective surface positioned in the third direction d3 with respect to the switching unit 22. For example, electromagnetic waves reflected in the third direction d3 in the switching unit 22 can undergo total reflection at the interfaces of the prisms constituting the separation unit 21 in the configuration described above. In this configuration, the first detection unit 13 is provided in the direction of reflection from the interfaces.

As a result of the first detection unit 13 being disposed as described above, in the first state, the switching elements se make the first portion of the electromagnetic waves travel to the first detection unit 13. In the second state, the switching elements se do not allow the first portion of the electromagnetic waves to travel to the first detection unit 13.

The switching unit 22 may include, for example, a digital micro mirror device (DMD). The DMD can switch the reflective surface in each switching element se to either a +12° or 12° inclination with respect to the action surface as by driving small reflective surfaces constituting the action surface as. The action surface as may be parallel to the substrate surface of the substrate on which the small reflective surfaces of the DMD are placed.

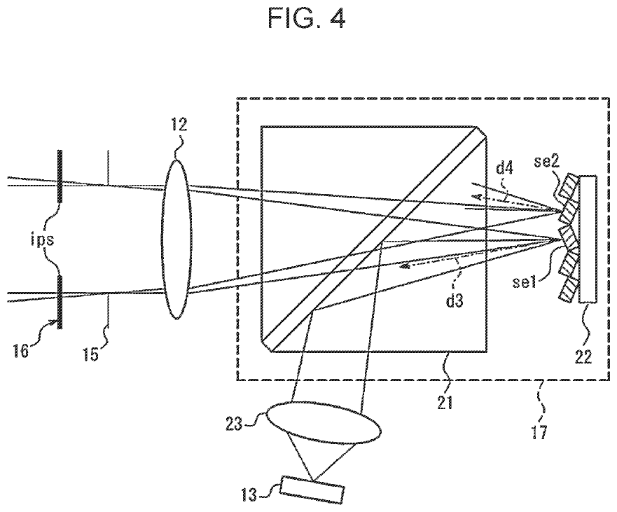

The switching unit 22 may switch between the first and second states in each switching element se based on control performed by the controller 18 described below. For example, as illustrated in FIG. 4, the switching unit 22 can simultaneously switch some switching elements se1 to the first state so as to make the electromagnetic waves incident on the switching elements se1 travel in the third direction d3 and switch some other switching elements se2 to the second state so as to make the electromagnetic waves incident on the switching elements se2 travel in the fourth direction d4.

A secondary image-forming optical system 23 may be provided between the first detection unit 13 and the switching unit 22. The secondary image-forming optical system 19 may include, for example, at least one out of a lens and a mirror. The secondary image-forming optical system 23 may form an image of the object ob from electromagnetic waves whose direction of travel has been switched in the switching unit 22.

When the first detection unit 13 is a single element constituting a distance measurement sensor as described above, the first detection unit 13 only needs to be able to detect electromagnetic waves, and an image of an object does not need to be formed on the detection surface. Therefore, the first detection unit 13 does not need to be provided at a secondary image formation position, which is an image formation position determined by the secondary image-forming optical system 23. In other words, in this configuration, the first detection unit 13 may be disposed anywhere along the path of the electromagnetic waves that have been made to travel in the third direction d3 by the switching unit 22 and then travel through the secondary image-forming optical system 23, so long as electromagnetic waves from all angles of view can be made incident on the detection surface.

The controller 18 includes one or more processors and memories. Such processors may include at least either of general-purpose processors into which specific programs are loaded in order to perform specific functions and dedicated processors dedicated to specific processing. Dedicated processors may include an application specific integrated circuit (ASIC). Processors may include programmable logic devices (PLDs). PLDs may include field-programmable gate arrays (FPGAs). The controller 18 may be either a system-on-a-chip (SoC) or a system in a package (SiP), in which one or more processors work together.

Based on the detection of electromagnetic waves by the first detection unit 13, the controller 18 acquires first spatial information about the space into which the radiating unit 11 radiated the electromagnetic waves. The controller 18 acquires second spatial information about the space based on the detection of electromagnetic waves by the second detection unit 14.

The resolution of the first spatial information is lower than the resolution of the second spatial information. Here, the term “resolution” refers to the density of information that the first detection unit 13 and the second detection unit 14 acquire from the space into which the radiating unit 11 radiates electromagnetic waves. More specifically, for example, the distance information acquired by the first detection unit 13 may be distance information for each region corresponding to multiple adjacent pixels out of image information acquired by the second detection unit 14. The first spatial information and the second spatial information may be, for example, image information, distance information, or temperature information. In this embodiment, the controller 18 may acquire distance information by performing ranging on an object located in a radiation direction of the radiating unit 11 based on detection information detected by the first detection unit 13. More specifically, the controller 18 may generate distance information using the Time-of-Flight (ToF) method, as described below. In this embodiment, the controller 18 acquires the electromagnetic waves detected by the second detection unit 14 as image information. In this embodiment, the controller 18 can calculate the radiation direction based on a driving signal that is input to make the reflecting unit 20 change the direction in which the electromagnetic waves are reflected.

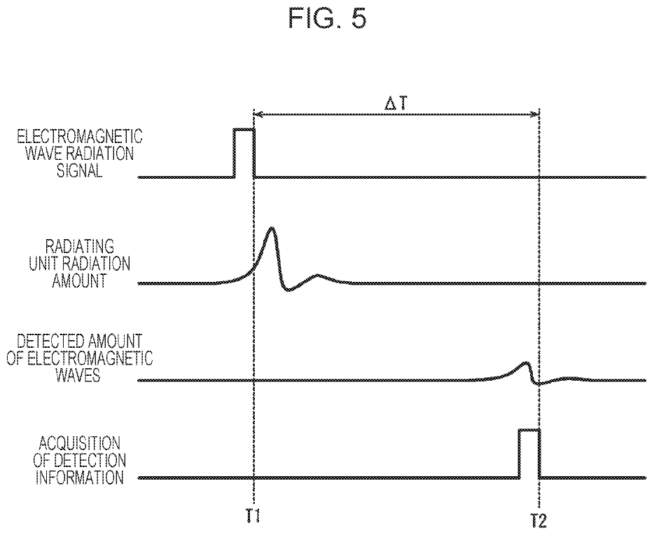

As illustrated in FIG. 5, the controller 18 may cause the light source 19 to emit pulsed electromagnetic waves by inputting an electromagnetic wave radiation signal to the light source 19 in the radiating unit 11 (refer to “electromagnetic wave radiation signal”). The light source 19 may radiate electromagnetic waves based on the input electromagnetic wave radiation signal (refer to “radiating unit radiation amount”). The electromagnetic waves emitted by the light source 19, reflected by the reflecting unit 20, and radiated onto any irradiated region are reflected in that irradiated region. The controller 18 may switch at least some of the switching elements se in an image forming region in the switching unit 22, the image forming region corresponding to the reflected waves from that irradiated region through the incidence unit 12, to the first state and switch other switching elements se to the second state. Switching of the switching elements se may be performed prior to the radiation of the electromagnetic waves by the radiating unit 11. The controller 18 may switch the switching elements se to the first state each time the radiating unit 11 radiates pulsed electromagnetic waves in accordance with the next radiation direction of the electromagnetic waves to be realized by the reflecting unit 20. In other words, the controller 18 may then switch at least some of the switching elements se within the image forming region in the switching unit 22, the image-forming region corresponding to the reflected waves of the electromagnetic waves radiated from the radiating unit 11, to the first state and switch the other switching elements se to the second state. When the first detection unit 13 detects electromagnetic waves reflected in the irradiated region (refer to “detected amount of electromagnetic waves”), the first detection unit 13 notifies the controller 18 of the detection information, as described above.

The controller 18 may include a time measurement large scale integrated circuit (LSI). The controller 18 may measure a time ΔT from a time T1 when the radiating unit 11 is made to radiate electromagnetic waves to a time T2 when the detection information is acquired (refer to “acquisition of detection information”). The controller 18 may calculate the distance to an irradiated position by multiplying the time ΔT by the speed of light and then dividing by 2. The controller 18 may calculate the irradiated position based on the driving signal output to the reflecting unit 20, as described above. The controller 18 may create distance information in the form of an image by calculating the distance to each irradiated position corresponding to radiation directions while changing the radiation direction. As described above, the electromagnetic-wave detection device 10 is configured to create distance information using Direct ToF, in which the time taken from when a laser beam is emitted until the laser beam returns is directly measured, but is not limited to this configuration. For example, the electromagnetic-wave detection device 10 may create distance information using Flash ToF, in which electromagnetic waves are radiated at a fixed interval and the time taken for the electromagnetic waves to return is indirectly measured from the phase difference between the radiated and returning electromagnetic waves. The electromagnetic-wave detection device 10 may also create distance information using other ToF methods, for example, Phased ToF.

In a configuration in which the first aperture 15 is a variable aperture, the controller 18 may control the first aperture 15 so as to adjust the opening size of the first aperture 15. The depth of field of the first detection unit 13 can be appropriately adjusted by adjusting the aperture of the first aperture 15. The controller 18 may adjust the opening size of the first aperture 15 in accordance with the resolution required for the first spatial information acquired by the first detection unit 13. The controller 18 may accept input of the resolution required for the first spatial information. Together with adjusting the opening size, the controller 18 may control the switching unit 22 to change the number of switching elements se switched to the first state in accordance with the adjusted opening size. More specifically, the controller 18 may control the switching unit 22 to increase the number of switching elements se switched to the first state in accordance with the opening size. In this configuration, the controller 18 may increase the number of switching elements se switched to the first state as the opening size of the first aperture 15 becomes larger. Similarly, the controller 18 may decrease the number of switching elements se switched to the first state as the opening size of the first aperture 15 becomes smaller. The switching elements se that are switched to the first state may be a group of switching elements se centered on a switching element se corresponding to a point within the irradiated region.

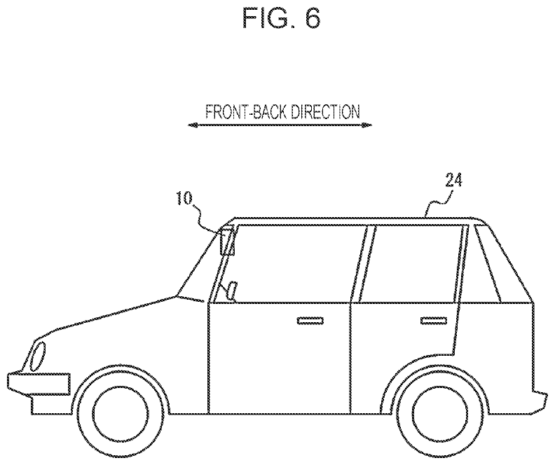

As illustrated in FIG. 6, the electromagnetic-wave detection device 10 may be installed in a mobile object 24. The electromagnetic-wave detection device 10 may be installed, for example, so as to be capable of detecting electromagnetic waves in front of the mobile object 24.

Examples of the mobile object 24 may include vehicles, ships, and aircraft. Vehicles may include, for example, automobiles, industrial vehicles, rail vehicles, motorhomes, and fixed-wing aircraft that taxi along runways. Automobiles may include, for example, passenger cars, trucks, buses, motorcycles, and trolleybuses. Industrial vehicles may include, for example, industrial vehicles used in agriculture and construction. Industrial vehicles may include, for example, forklift trucks and golf carts. Industrial vehicles used in agriculture may include, for example, tractors, cultivators, transplanters, binders, combine harvesters, and lawn mowers. Industrial vehicles used in construction may include, for example, bulldozers, scrapers, excavators, cranes, dump trucks, and road rollers. Vehicles may include vehicles that are human powered. The categories of vehicles are not limited to the above examples. For example, automobiles may include industrial vehicles that can travel along roads. The same vehicles may be included in multiple categories. Ships may include, for example, jet skis, boats, and tankers. Examples of aircraft may include fixed-wing aircraft and rotary-wing aircraft.

The electromagnetic-wave detection device 10 may, for example, be installed inside the mobile object 24 and detect electromagnetic waves incident from outside the mobile object 24 through the windshield. The electromagnetic-wave detection device 10 may be disposed in front of the rear view mirror or on the dashboard. The electromagnetic-wave detection device 10 may be fixed to any out of a front bumper, a fender grille, a side fender, a light module, and a hood of the mobile object 24.

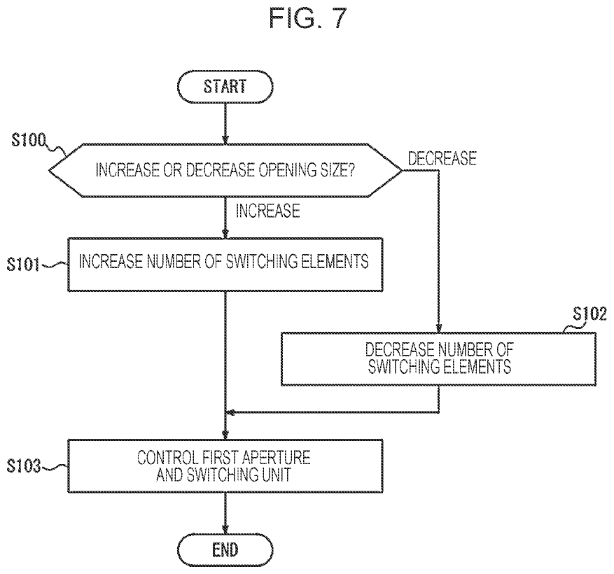

Next, opening adjustment processing performed by the controller 18 in this embodiment will be described using the flowchart in FIG. 7. The opening adjustment processing is initiated when an adjustment to the opening size is to be determined. An adjustment to the opening size may be determined based on a judgment carried out by the controller 18. The judgment carried out by the controller 18 may be based on adjustment input made to a detection unit that detects user input or various information.

In Step S100, the controller 18 determines whether an opening size that reflects the determined adjustment is an increase or a decrease from the current opening size. When the opening size is to be increased, the process advances to Step S101. When the opening size is to be decreased, the process advances to Step S102.

In Step S101, the controller 18 decides to increase the number of switching elements se switched to the first state. After the decision, the process advances to Step S103.

In Step S102, the controller 18 decides to decrease the number of switching elements se switched to the first state. After the decision, the process advances to Step S103.

In Step S103, the controller 18 controls the first aperture 15 so that the first aperture 15 comes to have the opening size that reflects the determined adjustment, and starts controlling the number of the switching elements se decided in Step S101 or Step S102 to the first state. After controlling the first aperture 15 and the switching unit 22, the aperture adjustment processing is completed.

The electromagnetic-wave detection device 10 of this embodiment having the above-described configuration includes the first aperture 15, the second aperture 16, and the controller 18. The first aperture 15 has the first region a1 that allows electromagnetic waves traveling to the first detection unit 13 and the second detection unit 14 to pass therethrough. The second aperture 16 has the second region a2 that allows electromagnetic waves traveling to the first detection unit 13 and the second detection unit 14 to pass therethrough and is smaller than the first region a1, and has the third region a3 that is located around the second region a2 and does not allow electromagnetic waves traveling to the second detection unit 14 to pass therethrough. The controller 18 acquires the first spatial information about the space based on the detection of electromagnetic waves performed by the first detection unit 13 and acquires the second spatial information about the space based on detection of electromagnetic waves performed by the second detection unit 14. The resolution of the first spatial information is lower than the resolution of the second spatial information. In an optical system that forms an image from electromagnetic waves, increasing the size of the aperture increases the amount of electromagnetic waves that pass through the optical system while reducing the depth of field. In such a situation, the electromagnetic-wave detection device 10 having the above-described configuration can adjust the amount of electromagnetic waves that reach the first detection unit 13 using the first aperture 15, which has a wider region through which electromagnetic waves can pass than the second aperture 16. Thus, the electromagnetic-wave detection device 10 is able to increase the amount of electromagnetic waves that reach the first detection unit 13 while increasing the depth of field for the second detection unit 14 using the second aperture 16. As a result, in the electromagnetic-wave detection device 10, the incidence unit 12, which is shared by multiple detectors such as the first detection unit 13 and the second detection unit 14, can be given optical characteristics that are suitable for each detector.

In the electromagnetic-wave detection device 10 of this embodiment, the first region a1 of the first aperture 15 has a long diameter in a direction that intersects the arrangement direction of the radiating unit 11 and the incidence unit 12. As described above, in the electromagnetic-wave detection device 10, in a configuration in which the position where electromagnetic waves radiated to the object ob are radiated and the position at which the electromagnetic waves are incident on the incidence unit 12 are different from each other, the radiating unit 11 and the incidence unit 12 need to be brought closer together in order to improve the positional accuracy of the detection results of the first detection unit 13. On the other hand, the first region a1 needs to have a prescribed size in order to allow the electromagnetic waves to enter. If the first region a1 is made perfectly circular or square, for example, disposing the radiating unit 11 and the incidence unit 12 close together in the arrangement direction, in order to avoid interference between the incidence unit 12 and the first aperture 15, is difficult. Regarding such a situation, in the electromagnetic-wave detection device 10 having the above configuration, the radiating unit 11 and the incidence unit 12 can be brought close together because a sufficient amount of electromagnetic waves can reach the first detection unit 13 even though the first region a1 has a small diameter in the arrangement direction of the radiating unit 11 and the incidence unit 12. Therefore, the electromagnetic-wave detection device 10 improves the positional accuracy of the detection results of the first detection unit 13. The radiating unit 11 and the incidence unit 12 may be disposed so that the center of the optical axis of the radiating unit 11 and the center of the optical axis of the incidence unit 12 are aligned vertically or horizontally. With this arrangement, deviation between the radiation direction of the electromagnetic waves radiated by the radiating unit 11 and the angle of view of the incidence unit 12 can be reduced, and the range across which the first spatial information is acquired can be widened.

In the electromagnetic-wave detection device 10 of this embodiment, the second aperture 16 is disposed on the object side from the incidence unit 12. As described above, the second aperture 16, which has the third region a3 that does not allow electromagnetic waves traveling to the second detection unit 14 to pass therethrough but does allow electromagnetic waves traveling to the first detection unit 15 to pass therethrough, is formed so as to be thicker than the first aperture 15. More specifically, the thicknesses of the second region a2 and the third region a3 are greater than the thickness of the first region a1. As illustrated in FIG. 4, as the thickness of an aperture is increased, reflected waves, out of the electromagnetic waves, are more likely to occur at an inner peripheral surface ips of the aperture. Therefore, if a relatively thick aperture is disposed inside the incidence unit 12, reflected waves reflected at the inner peripheral surface of the aperture may become noise. Regarding such a situation, in the electromagnetic-wave detection device 10 having the above-described configuration, since the possibility of reflected waves, which are a source of noise, entering the optical system 17 can be reduced, noise can be reduced.

The electromagnetic-wave detection device 10 of this embodiment can switch some of the switching elements se in the switching unit 22 to the first state and switch some other switching elements se to the second state. With this configuration, the electromagnetic-wave detection device 10 is able to detect information based on the electromagnetic waves using the first detection unit 13 for each part of the object ob which emits the electromagnetic waves incident on each switching element se. Therefore, the electromagnetic-wave detection device 10 blocks electromagnetic waves from reaching the first detection unit 13 from positions other than the irradiated positions of the electromagnetic waves radiated by the radiating unit 11. As a result, the electromagnetic-wave detection device 10 can improve the detection accuracy of reflected waves at the irradiated positions.

The electromagnetic-wave detection device 10 of this embodiment also changes the number of switching elements se that are switched to the first state in accordance with the opening size of the first aperture 15. The width of the spot of electromagnetic waves formed on the action surface as of the switching unit 22 changes in accordance with the opening size of the first aperture 15. Regarding such an situation, the electromagnetic-wave detection device 10 having the above-described configuration can switch the switching elements se to the first state in accordance with the width of the spot. Therefore, the electromagnetic-wave detection device 10 can reduce the amount of reflected waves in the irradiated region that reach the first detection unit 13.

Embodiments of the present disclosure have been described based on the drawings and examples, but note that a variety of variations and amendments may be easily made by one skilled in the art based on the present disclosure. Therefore, note that such variations and amendments are included within the scope of the present disclosure. For example, the functions and so forth included in each component or step can be rearranged in a logically consistent manner, and a plurality of components or steps can be combined into a single component or step or a single component or step can be divided into a plurality of components or steps. Although embodiments of the present disclosure have been described while focusing on devices, the embodiments of the present disclosure can also be realized as a method including steps executed by individual component of the device. The embodiments of the present disclosure can also be realized as a method executed by a processor included in a device, a program, or a storage medium recording the program. Please understand that the scope of the present disclosure also includes these forms.

For example, the switching unit 22 of this embodiment is configured to reflect electromagnetic waves incident on the action surface as in the first state in the third direction d3 and to reflect electromagnetic waves incident on the action surface as in the second state in the fourth direction d4, but other configurations may be employed.

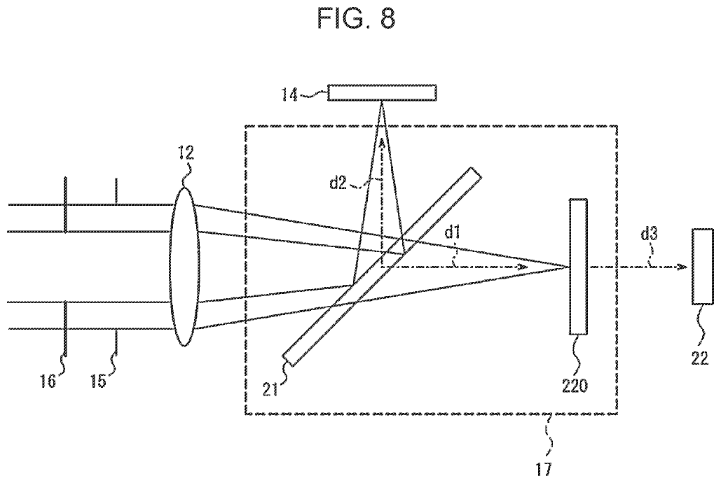

For example, as illustrated in FIG. 8, a switching unit 220 may allow the electromagnetic waves incident on the action surface as in the first state to pass therethrough and cause the electromagnetic waves to travel in the third direction d3. The switching unit 220 may further specifically include a shutter having a reflective surface that reflects electromagnetic waves in a fourth direction for each switching element. In the switching unit 220 of this configuration, propagation in the third direction d3 and propagation in the fourth direction d4 can be switched in each switching element by opening and closing the shutter for each switching element.

The switching unit 220 in this configuration includes, for example, a switching unit that includes a MEMS shutter with an array of multiple shutters that can be opened and closed. Examples of the switching unit 220 include a switching unit that includes a liquid crystal shutter that can switch between a reflecting state in which electromagnetic waves are reflected and a transmitting state in which electromagnetic waves are transmitted in accordance with the liquid crystal orientation.

In this embodiment, the electromagnetic-wave detection device 10 has a configuration in which a beam of electromagnetic waves radiated from the radiating unit 11 is scanned by the reflecting unit 20, and the first detection unit 13 is made to function as a scanning active sensor in cooperation with the reflecting unit 20. However, the electromagnetic-wave detection device 10 is not limited to this configuration. For example, an effect similar to that of this embodiment may be obtained if the electromagnetic-wave detection device 10 does not include the reflecting unit 20, and has a configuration in which radiating electromagnetic waves are emitted from the radiating unit 11 and information is acquired without scanning.

In the present disclosure, “first”, “second,” and so on are identifiers used to distinguish between such configurations. Regarding the configurations, “first”, “second”, and so on used to distinguish between the configurations in the present disclosure may be exchanged with each other. For example, identifiers “first” and “second” may be exchanged between a first detection unit and a second detection unit. Exchanging of the identifiers take places simultaneously. Even after exchanging the identifiers, the configurations are distinguishable from each other. The identifiers may be deleted. The configurations that have had their identifiers deleted are distinguishable from each other by symbols. Just the use of identifiers such as “first” and “second” in this disclosure is not to be used as a basis for interpreting the order of such configurations or the existence of identifiers with smaller numbers.

Many aspects of the content of the present disclosure are presented as a series of operations executed by a computer system or other hardware capable of executing program instructions. Computer systems and other hardware include, for example, general-purpose computers, personal computers (PCs), dedicated computers, workstations, personal communications system (PCS), mobile (cellular) telephones, mobile telephones with data processing capabilities, RFID receivers, games consoles, electronic notepads, laptop computers, global positioning system (GPS) receivers or other programmable data processing devices. Note that in each embodiment, various operations are performed by dedicated circuits (for example, individual logic gates interconnected to perform specific functions) implemented using program instructions (software), or by logic blocks or program modules executed by one or more processors. Examples of the one or more processors, which execute components such as logic blocks and program modules, include one or more microprocessors, a central processing unit (CPU), an application specific integrated circuit (ASIC), a digital signal processor (DSP), a programmable logic device (PLD), a field programmable gate array (FPGA), a processor, a controller, a micro-controller, a microprocessor, an electronic device, other devices designed to be able to perform the functions described herein, and/or a combination of the devices described herein. The embodiments described herein are implemented, for example, using hardware, software, firmware, middleware, microcode, or any combination thereof. Instructions may be program code or code segments for performing the required tasks. The instructions can be stored in a machine-readable non-transitory storage medium or another medium. Code segments may represent any combination of procedures, functions, subprograms, programs, routines, subroutines, modules, software packages, classes or instructions, data structures or program statements. Code segments transmit and/or receive information, data arguments, variables or stored content from and/or to other code segments or hardware circuits, and in this way, connect to other code segments or hardware circuits.

Note that a system is disclosed herein as having various modules and/or units that perform specific functions. These modules and units are illustrated in a schematic manner in order to briefly illustrate their functionality and do not necessarily represent specific hardware and/or software. In that sense, these modules, units, and other components may be hardware and/or software implemented to substantially perform the specific functions described herein. The various functions of the different components may be any combination of hardware and/or software or hardware and/or software used separately from each other, and can be used separately or in any combination. In addition, input/output or I/O devices or user interfaces, including but not limited to keyboards, displays, touch screens, pointing devices, and so forth, can be connected directly to the system or via an I/O controller interposed therebetween. Thus, various aspects of the contents of the present disclosure can be implemented in numerous different ways, all of which are included within the scope of the present disclosure.

### REFERENCE SIGNS

10 electromagnetic-wave detection device
11 radiating unit
12 incidence unit
13 first detection unit
14 second detection unit
15 first aperture
16 second aperture
17 optical system
18 controller
19 light source
20 reflecting unit
21 separation unit
22 switching unit
23 secondary image-forming optical system
24 mobile object
as action surface
a1 first region
a2 second region
a3 third region
a4 region of first aperture outside first region
d1 first direction
d2 second direction
d3 third direction
d4 fourth direction
ips inner peripheral surface
ob object
se switching element

1. An electromagnetic-wave detection device comprising:
a radiating unit configured to radiate electromagnetic waves into a space;
an incidence unit on which electromagnetic waves are incident, the electromagnetic waves including reflected waves resulting from electromagnetic waves radiated by the radiating unit being reflected by an object;
a first detection unit configured to detect reflected waves incident from the incidence unit;
a second detection unit configured to detect electromagnetic waves incident from the incidence unit;
a first aperture having a first region that allows electromagnetic waves traveling to the first detection unit and the second detection unit to pass therethrough;
a second aperture having a second region and a third region, the second region allowing electromagnetic waves traveling to the first detection unit and the second detection unit to pass therethrough and being smaller than the first region, and the third region being located around the second region and not allowing electromagnetic waves traveling to the second detection unit to pass therethrough;
an optical system configured to, out of electromagnetic waves that have passed through the first aperture and the second aperture, guide a first portion, including the reflected waves, to the first detection unit and guide a second portion, excluding the first portion, to the second detection unit; and
a controller configured to acquire first spatial information about the space based on detection of electromagnetic waves by the first detection unit and to acquire second spatial information about the space based on detection of electromagnetic waves by the second detection unit,
wherein a resolution of the first spatial information is lower than a resolution of the second spatial information.

2. The electromagnetic-wave detection device according to claim 1,
wherein the first region has a long diameter in a direction that intersects a direction in which the radiating unit is disposed with respect to the incidence unit.

3. The electromagnetic-wave detection device according to claim 1,
wherein the second aperture is thicker than the first aperture, and
the second aperture is disposed on an object side from the incidence unit.

4. The electromagnetic-wave detection device according to claim l,
wherein the optical system includes a switching unit including switching elements configured to switch between a first state in which the first portion is made to travel to the first detection unit and a second state in which the first portion is not made to travel to the first detection unit, and
prior to radiation of the electromagnetic waves by the radiating unit, the controller switches some of the switching elements in the switching unit to the first state, the switching elements corresponding to at least the reflected waves of the first portion within an image forming region in the switching unit, and switches other switching elements to the second state.

5. The electromagnetic-wave detection device according to claim 4,
wherein an opening size of the first aperture is variable, and
the number of switching elements switched to the first state is changed in accordance with the opening size of the first aperture.

6. The electromagnetic-wave detection device according to claim 5,
wherein the controller determines the opening size of the first aperture in accordance with the resolution of the first spatial information input thereto.

7. The electromagnetic-wave detection device according to claim 1,
wherein the second region includes a wavelength filter that allows electromagnetic waves in a band that includes a wavelength of the electromagnetic waves radiated by the radiating unit and electromagnetic waves in a visible light band to pass therethrough, and
the third region includes a wavelength filter that allows electromagnetic waves in a band that includes the wavelength of the electromagnetic waves radiated by the radiating unit to pass therethrough and blocks electromagnetic waves in the visible light band.

8. The electromagnetic-wave detection device according to claim 1,
wherein the first spatial information is distance information, and
the second spatial information is image information.
